(19) United States
(12) Patent Application Publication
(10) Pub. No.: US 2022/0203413 A1
(43) Pub. Date: Jun. 30, 2022

(54) DUST REMOVAL APPARATUS, VEHICLE, AND DUST REMOVAL METHOD

(71) Applicant: TOYOTA JIDOSHA KABUSHIKI KAISHA, Aichi-ken (JP)

(72) Inventors: Shinichiro NODA, Toyota-shi (JP); Seiji HONDA, Toyota-shi (JP); Hironari TAYA, Toyota-shi (JP)

(21) Appl. No.: 17/557,057

(22) Filed: Dec. 21, 2021

(30) Foreign Application Priority Data
Dec. 25, 2020 (JP) 2020-217812

(51) Int. Cl. B08B 5/02; B03C 3/38; B08B 6/00

(52) U.S. Cl. CPC B08B 5/02; B08B 6/00; B03C 3/383

(57) ABSTRACT

A dust removal apparatus includes: a collecting portion configured to collect gas existing inside a work room configured to separate a space inside the work room from a space outside the work room in a state where the gas is not circulable; and a compression portion configured to compress the gas collected by the collecting portion. Further, the dust removal apparatus includes: a jetting portion configured to jet out the gas compressed by the compression portion, the jetting portion being provided in the space outside the work room; and an ionizer portion configured to mix ions into the gas to be jetted out of the jetting portion when a voltage is applied to the ionizer portion, the ionizer portion being provided between the compression portion and the jetting portion.

### CROSS-REFERENCE TO RELATED APPLICATION

This application claims priority to Japanese Patent Application No. 2020-217812 filed on Dec. 25, 2020, incorporated herein by reference in its entirety.

### BACKGROUND

### 1. Technical Field

The present disclosure relates to a dust removal apparatus, a vehicle, and a dust removal method.

### 2. Description of Related Art

Japanese Unexamined Patent Application Publication No. 2009-106843 (JP 2009-106843 A) describes an anti-static dust removal apparatus configured to remove electricity from a workpiece and remove foreign matter such as dust attached to the workpiece by blowing the workpiece with compressed air together with ions. The anti-static dust removal apparatus described herein includes an air-blast head configured to blast a workpiece with compressed air together with ions, and a transport conveyer configured to convey the workpiece. The air and the ions jetted out from the air-blast head are blown toward the workpiece conveyed by the transport conveyer, so that electricity and dust on the workpiece under conveyance can be removed.

### SUMMARY

In the meantime, depending on the environment where a dust removal apparatus for performing dust removal or the like is used, it is conceivable that there are many restrictions on securing gas to be jetted out with ions. However, the anti-static dust removal apparatus described in JP 2009-106843 A does not consider this point. For example, in a case of a dust removal apparatus to be used in environments other than the earth, e.g., the moon, Mars, and so on, the amount of gas usable in the dust removal apparatus, a transport cost of the gas from the earth must be taken into consideration.

The present disclosure is achieved in consideration of the above fact, and an object of the present disclosure is to provide a dust removal apparatus, a vehicle, and a dust removal method each of which can secure gas to be used for dust removal regardless of an environment where the dust removal is performed.

A dust removal apparatus according to a first aspect of the present disclosure includes a collecting portion, a compression portion, a jetting portion, and an ionizer portion. The collecting portion is configured to collect gas existing inside an internal space forming portion configured to separate a space inside the internal space forming portion from a space outside the internal space forming portion in a state where the gas is not circulable. The compression portion is configured to compress the gas collected by the collecting portion. The jetting portion is configured to jet out the gas compressed by the compression portion. The jetting portion is provided in the space outside the internal space forming portion. The ionizer portion is configured to mix ions into the gas jetted out of the jetting portion when a voltage is applied to the ionizer portion, the ionizer portion being provided between the compression portion and the jetting portion.

In the dust removal apparatus according to the first aspect, the gas existing in the internal space forming portion is collected by the collecting portion, and the gas thus collected by the collecting portion is compressed by the compression portion. Further, the gas compressed by the compression portion is jetted out of the jetting portion provided in the space outside the internal space forming portion. Further, when a voltage is applied to the ionizer portion, ions are mixed into the gas to be jetted out of the jetting portion. When a blast target object is hit by the gas mixed with the ions and jetted out of the jetting portion, dust can be removed from the blast target object. Here, in the dust removal apparatus according to the first aspect, the gas to be used to perform dust removal in the space outside the internal space forming portion is secured by collecting the gas from gases existing inside the internal space forming portion. Hereby, regardless of the environment of the space outside the internal space forming portion where the dust removal is performed, it is possible to secure the gas to be used for the dust removal.

A dust removal apparatus according to a second aspect is as follows. That is, in the dust removal apparatus according to the first aspect, the internal space forming portion may be provided in a state where the internal space forming portion is movable on a celestial object in outer space or in a state where the internal space forming portion is fixed to the celestial object in the outer space.

In the dust removal apparatus according to the second aspect, even in a case where the environment of the space outside the internal space forming portion where the dust removal is performed is generally in a vacuum state, it is possible to secure the gas to be used for the dust removal.

A dust removal apparatus according to a third aspect is as follows. That is, in the dust removal apparatus according to the first aspect or the second aspect, the collecting portion may collect at least one of carbon dioxide and steam from among gases existing inside the internal space forming portion.

In the dust removal apparatus according to the third aspect, unnecessary carbon dioxide and steam existing inside the internal space forming portion can be used as gas for dust removal.

A dust removal apparatus according to a fourth aspect is as follows. That is, the dust removal apparatus according to any one of the first to third aspects may further include a controlling portion configured to, based on information on a blast target object to be hit by gas jetted from the jetting portion and powder dust attached to the blast target object, adjust a flow speed of the gas to be jetted out of the jetting portion.

In the dust removal apparatus according to the fourth aspect, based on the information on the blast target object to be hit by the gas jetted out of the jetting portion and the powder dust attached to the blast target object, the controlling portion adjusts the flow speed of the gas to be jetted out of the jetting portion. Hereby, it is possible to more surely remove the powder dust attached to the blast target object.

A dust removal apparatus according to a fifth aspect is as follows. That is, in the dust removal apparatus according to the fourth aspect, the controlling portion may adjust a voltage to be applied to the ionizer portion based on information on a potential around the internal space forming portion.

In the dust removal apparatus according to the fifth aspect, the controlling portion adjusts a voltage to be applied to the ionizer portion based on information on a potential around the internal space forming portion. Hereby, it is possible to further restrain reattachment of the powder dust removed from the blast target object.

A dust removal apparatus according to a sixth aspect is as follows. That is, in the dust removal apparatus according to any one of the first to fifth aspects, the internal space forming portion may include a power generation portion configured to generate electric power upon receipt of light. The gas may be jetted out of the jetting portion to the power generation portion.

With the dust removal apparatus according to the sixth aspect, it is possible to effectively remove the powder dust attached to the power generation portion.

A dust removal apparatus according to a seventh aspect is as follows. That is, in the dust removal apparatus according to any one of the first to sixth aspects, the internal space forming portion may include a heat dissipation portion configured to dissipate heat. The gas may be jetted out of the jetting portion to the heat-dissipation portion.

With the dust removal apparatus according to the seventh aspect, it is possible to effectively remove the powder dust attached to the heat dissipation portion.

A vehicle according to an eighth aspect includes a vehicle main body, a collecting portion, a compression portion, a jetting portion, and an ionizer portion. The vehicle main body has a space inside which an occupant rides. The vehicle main body is configured to separate the space inside the vehicle main body from a space outside the vehicle in a state where no gas is circulable. The vehicle main body is configured to travel on ground. The collecting portion is configured to collect gas existing inside the vehicle main body. The compression portion is configured to compress the gas collected by the collecting portion. The jetting portion is configured to jet out the gas compressed by the compression portion. The jetting portion is provided in the space outside the vehicle main body. The ionizer portion is configured to mix ions into the gas to be jetted out of the jetting portion when a voltage is applied to the ionizer portion. The ionizer portion is provided between the compression portion and the jetting portion.

In the vehicle according to the eighth aspect, the gas existing inside the vehicle main body is collected by the collecting portion, and the gas thus collected by the collecting portion is compressed by the compressing portion. Further, the gas compressed by the compression portion is jetted out of the jetting portion provided in the space outside the vehicle main body. Further, when a voltage is applied to the ionizer portion, ions are mixed into the gas to be jetted out of the jetting portion. When a blast target object is hit by the gas mixed with the ions and jetted out of the jetting portion, dust can be removed from the blast target object. Here, in the vehicle according to the eighth aspect, gas to be used to perform dust removal in the space outside the vehicle main body is secured by collecting the gas from gases existing inside the vehicle main body. Hereby, regardless of the environment of the space outside the vehicle main body where the dust removal is performed, it is possible to secure the gas to be used for the dust removal.

A dust removal method according to a ninth aspect includes: a gas collecting step of collecting gas existing inside an internal space forming portion configured to separate a space inside the internal space forming portion from a space outside the internal space forming portion in a state where the gas is not circulable; a compression step of compressing the gas collected in the gas collecting step; an ion mixing step of mixing ions into the gas when the gas compressed in the compression step is expanded; and a jetting step of jetting out the gas mixed with the ions in the ion mixing step to a blast target object in the space outside the internal space forming portion.

In the dust removal method according to the ninth aspect, first, in the gas collecting step, gas existing inside the internal space forming portion is collected. Then, in the compression step, the gas collected in the gas collecting step is compressed. Subsequently, in the ion mixing step, ions are mixed into the gas when the gas compressed in the compression step is expanded. Subsequently, in the jetting step, the gas mixed with the ions in the ion mixing step is jetted out to a blast target object in the space outside the internal space forming portion. Here, in the dust removal method according to the ninth aspect, the gas to be used to perform dust removal in the space outside the internal space forming portion is secured by collecting the gas from gases existing inside the internal space forming portion. Hereby, regardless of the environment of the space outside the internal space forming portion where the dust removal is performed, it is possible to secure the gas to be used for the dust removal.

A dust removal method according to a tenth aspect is as follows. That is, in the dust removal method according to the ninth aspect, based on information on a blast target object to be hit by the gas jetted out in the jetting step and powder dust attached to the blast target object, a flow speed of the gas to be jetted out in the jetting step may be adjusted.

In the dust removal method according to the tenth aspect, based on the information on the blast target object to be hit by the gas jetted out in the jetting step and the powder dust attached to the blast target object, the flow speed of the gas to be jetted out in the jetting step is adjusted. Hereby, it is possible to more surely remove the powder dust attached to the blast target object.

A dust removal method according to an eleventh aspect is as follows. That is, in the dust removal method according to the tenth aspect, a voltage to be applied in the ion mixing step may be adjusted based on information on a potential around the internal space forming portion.

In the dust removal method according to the eleventh aspect, the voltage to be applied in the ion mixing step is adjusted based on the information on the potential around the internal space forming portion. Hereby, it is possible to further restrain reattachment of the powder dust removed from the blast target object.

The dust removal apparatus, the vehicle, and the dust removal method according to the present disclosure have an excellent effect that gas to be used for dust removal can be secured regardless of the environment where the dust removal is performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating a dust removal apparatus according to a first embodiment;

FIG. 2 is a schematic view illustrating a jetting portion of a type to be used such that the jetting portion is carried on the shoulder of a crew member;

FIG. 3 is a schematic view illustrating a jetting portion of a type to be moved by a robot arm;

FIG. 4 is a schematic view illustrating a dust removal apparatus according to a second embodiment;

FIG. 5 is a block diagram illustrating a controlling portion and so on;

FIG. 6 is a flowchart to describe a control performed by the controlling portion;

FIG. 7 is a schematic view illustrating a dust removal apparatus according to a third embodiment;

FIG. 8 is a schematic view illustrating a vehicle including a dust removal apparatus according to a fourth embodiment; and

FIG. 9 is a perspective view illustrating a jetting portion having a plurality of jetting openings.

### DETAILED DESCRIPTION OF EMBODIMENTS

Dust Removal Apparatus 10 according to First Embodiment

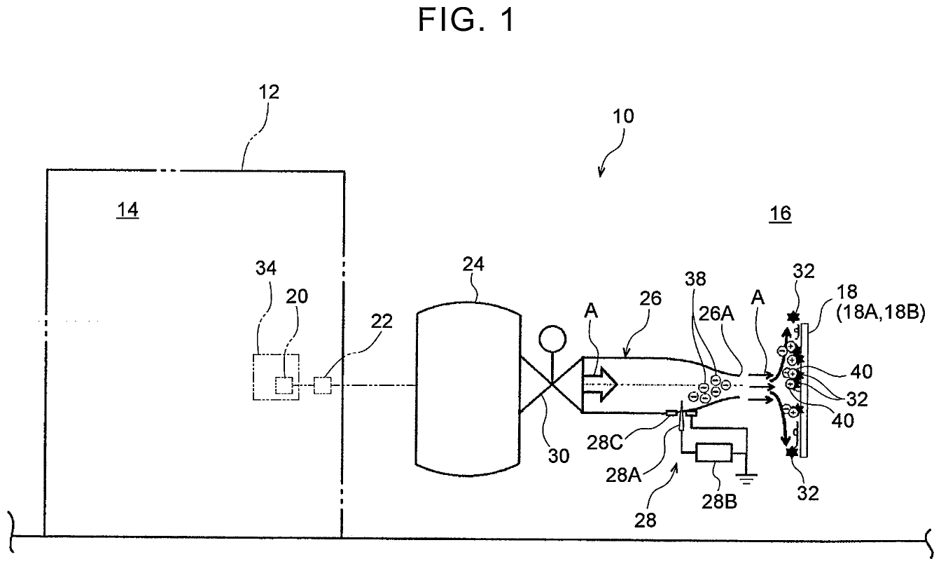

The following describes a dust removal apparatus 10 according to a first embodiment of the present disclosure with reference to FIGS. 1 to 3.

FIG. 1 illustrates the dust removal apparatus 10 configured to remove dust from a target object 18 provided in a space 16 outside a work room 12 by use of gas in a space 14 inside the work room 12. The work room 12 serves as an internal space forming portion provided on the surface of the moon. As illustrated herein, the dust removal apparatus 10 includes a collecting portion 20 configured to collect gas present in the space 14 inside the work room 12, a compression portion 22 configured to compress the gas collected by the collecting portion, and a storage portion 24 in which the gas compressed by the compression portion 22 is stored. Further, the dust removal apparatus 10 includes a jetting portion 26 configured to jet out the gas stored in the storage portion 24, and a flow rate adjusting portion 30 configured to adjust the flow rate and the flow speed of the gas jetted out of the jetting portion 26 by adjusting the flow rate of the gas flowing from the storage portion 24 to the jetting portion 26 side. Further, the dust removal apparatus 10 includes an ionizer portion 28 configured to mix ions into the gas to be jetted out of the jetting portion 26 when a voltage is applied thereto. The ionizer portion 28 is provided between the compression portion 22 and the jetting portion 26.

The work room 12 is a space craft or a space building provided in a state where the work room 12 is movable on the surface of the moon or in a state where the work room 12 is fixed to the surface of the moon. The moon is a celestial object existing in the outer space. The work room 12 separates the space 14 inside the work room 12 from the space 16 outside the work room 12 in a state where no gas is passable between the space 14 and the space 16. Here, the configuration in which the space 14 inside the work room 12 is separated from the space 16 outside the work room 12 in a state where no gas is passable between the space 14 and the space 16 includes a configuration including a mechanism that temporarily establishes a state where gas is passable between the space 14 and the space 16, as well as a configuration in which the space 14 is always separated from the space 16 in a state where no gas is passable therebetween.

The space 14 inside the work room 12 is filled with air adjusted to a predetermined temperature, a predetermined humidity, and a predetermined pressure. The space 16 outside the work room 12 is a space on the surface of the moon. There is almost no air in the space 16, and the space 16 is generally in a vacuum state. Further, the gravitational force on the surface of the moon is a one-sixth of the gravitational force on the surface of the earth. Further, the surface of the moon is covered with a layer called regolith 32 and made of fragments generated by meteorites. Note that the regolith 32 includes fragments of various sizes from very small powder dust to large rocks having a diameter of about 0.8 m, but the dust removal apparatus 10 of the present embodiment is used to remove the regolith 32 that is very small powder dust attached to the target object 18.

The target object 18 as a blast target object is a solar panel 18A as a power generation portion provided in the space 16 outside the work room 12 or a radiator 18B as a heat dissipation portion also provided in the space 16 outside the work room 12. The solar panel 18A performs power generation upon receipt of light such as sunlight. Electricity generated by the solar panel 18A can be used inside the work room 12 and around the work room 12. Further, the radiator 18B is intended to dissipate heat from various devices, and liquid for cooling flows inside the radiator 18B. Hereby, heat of various devices is dissipated to the space (the space 16 outside the work room 12) on the surface of the moon via the radiator 18B.

The collecting portion 20 constitutes part of a life support system 34 configured to maintain the temperature, the humidity, the pressure, and so on of the space 14 inside the work room 12 to a predetermined state. The collecting portion 20 of the present embodiment is configured to collect unnecessary carbon dioxide and steam in the space 14 inside the work room 12. Note that, in the following description, carbon dioxide and steam collected by the collecting portion 20 are referred to as “dust removal gas.” Further, the unnecessary carbon dioxide and steam in the space 14 inside the work room 12 are mainly exhaled breath from a crew inside the work room 12. Note that the collecting portion 20 may be configured to collect only carbon dioxide or may be configured to collect only steam.

The compression portion 22 is a compressor configured to compress the dust removal gas collected by the collecting portion 20. When the compression portion 22 operates, the dust removal gas collected by the collecting portion 20 is compressed.

The storage portion 24 is a tank in which the dust removal gas compressed by the compression portion 22 is stored, and the storage portion 24 is formed in a cylindrical shape the axially opposite ends of which are closed by semispherical cover members, as one example.

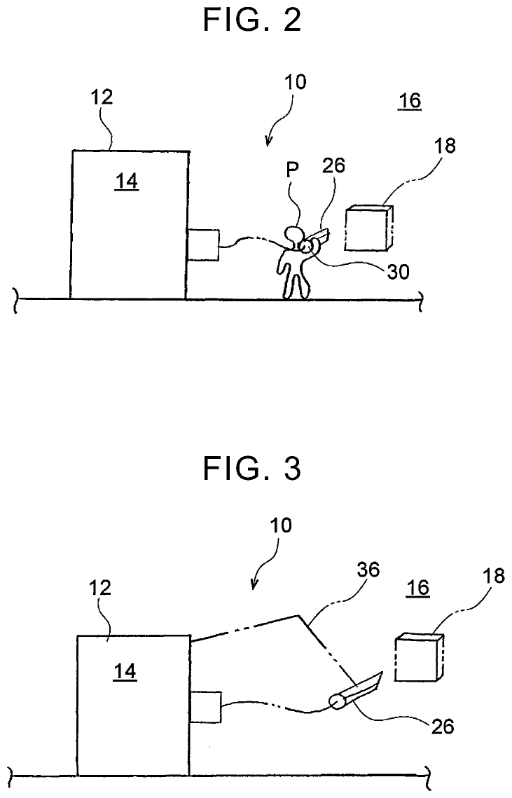

The jetting portion 26 is a convergent nozzle formed such that its distal end side is narrowed. When the dust removal gas stored in the storage portion 24 passes through the jetting portion 26, the dust removal gas can be jetted out from a distal end opening 26A of the jetting portion 26. Further, as illustrated in FIG. 2, the jetting portion 26 may be configured to be displaceable from the storage portion 24 together with the flow rate adjusting portion 30 (described later) such that a crew member P in the space 16 outside the work room 12 can use the jetting portion 26 with the jetting portion 26 being carried on the shoulder of the crew member P. In this case, the crew member P adjusts the direction of the jetting portion 26 and the distance between the jetting portion 26 and the target object 18 and also operates the flow rate adjusting portion 30. Further, as illustrated in FIG. 3, the jetting portion 26 may be configured to be attached to a robot arm 36 provided in the space 16 outside the work room 12. In this case, the robot arm 36 adjusts the direction of the jetting portion 26 and the distance between the jetting portion 26 and the target object 18. Note that, in FIG. 1, the flow of the dust removal gas jetted out of the jetting portion 26 is indicated by an arrow A.

As illustrated in FIG. 1, the flow rate adjusting portion 30 is a regulator provided between the storage portion 24 and the jetting portion 26. When the flow rate adjusting portion 30 is manually or automatically operated, the dust removal gas is allowed to flow from the storage portion 24 to the jetting portion 26 side, and the flow rate of the dust removal gas to flow from the storage portion 24 to the jetting portion 26 side is adjusted, so that the flow rate and the flow speed of the dust removal gas jetted out of the jetting portion 26 are adjusted.

The ionizer portion 28 is a voltage-application-type static eliminator. The ionizer portion 28 includes a discharge electrode 28A provided in the middle of the jetting portion 26, a power supply 28B configured to apply a high voltage to the discharge electrode 28A, and an earth electrode 28C provided in the middle of the jetting portion 26 and also around the discharge electrode 28A. When a voltage is applied to the discharge electrode 28A, ions can be mixed into the dust removal gas inside the jetting portion 26. Here, in a case where the dust removal gas is carbon dioxide and steam, CO₂⁻ and O₂⁻ ions can be mixed into the dust removal gas. Note that, in FIG. 1, CO₂⁻ and O₂⁻ ions are expressed as particles indicated by a reference sign 38.

Dust Removal Method Using Dust Removal Apparatus 10

Next will be described a dust removal method using the dust removal apparatus 10 of the present embodiment.

By use of the dust removal apparatus 10 described above, first, unnecessary carbon dioxide and steam in the space 14 inside the work room 12 are collected by the collecting portion 20 constituting part of the life support system 34. That is, the dust removal gas is collected by the collecting portion 20. Note that this step is referred to as a “gas collecting step.”

Subsequently, the compression portion 22 is operated so as to compress the dust removal gas collected in the gas collecting step. Note that this step is referred to as a “compression step.” The dust removal gas compressed in the compression step is stored in the storage portion 24.

Subsequently, the flow rate adjusting portion 30 is operated such that the dust removal gas flows from the storage portion 24 toward the jetting portion 26 side while the dust removal gas is expanded, and the ionizer portion 28 is also operated such that ions are mixed into the dust removal gas inside the jetting portion 26. Note that this step is referred to as an “ion mixing step.” Then, the dust removal gas mixed with the ions through the ion mixing step are jetted out of the jetting portion 26 to the solar panel 18A or the radiator 18B as the target object 18. Note that this step is referred to as a “jetting step.” In the jetting step, the regolith 32 attached to the solar panel 18A or the radiator 18B is removed, so that a decrease in the power generation amount of the solar panel 18A or a decrease in the heat dissipation amount of the radiator 18B is restrained.

Operations and Effects of Present Embodiment

Operations and effects of the present embodiment are described below.

In the dust removal apparatus 10 of the present embodiment described above, although the environment of the space 16 outside the work room 12 where dust removal is performed is generally in a vacuum state, it is possible to secure the dust removal gas to be used for the dust removal.

Further, in the present embodiment, the collecting portion 20 is configured to collect unnecessary carbon dioxide and steam in the space 14 inside the work room 12 as the dust removal gas. Hereby, carbon dioxide and steam as gases originally discharged to the space 16 outside the work room 12 can be effectively utilized as the dust removal gas. As a result, it is possible to reduce the conveyance amount and the transport cost of the dust removal gas from the earth to the moon.

Further, in the present embodiment, the jetting portion 26 has a convergent nozzle shape the distal end side of which is narrowed. Hereby, inertia force of the dust removal gas can be raised on the distal end side of the jetting portion 26, and at the same time, the pressure of the dust removal gas can be also decreased. As a result, while the expansion of the dust removal gas in the distal end opening 26A of the jetting portion 26 is restrained, that is, while a reduction in the jetting speed of the dust removal gas in the distal end opening 26A of the jetting portion 26 as a high vacuum part is restrained, the solar panel 18A or the radiator 18B as the target object 18 can be hit by the dust removal gas jetted out of the jetting portion 26.

Further, in the present embodiment, the dust removal gas mixed with the ions is jetted out of the jetting portion 26 to the solar panel 18A or the radiator 18B as the target object 18. Accordingly, when the dust removal gas mixed with the ions hits the charged regolith 32 attached to the surface of the solar panel 18A or the radiator 18B, static electricity of the regolith 32 is removed. As a result, the regolith 32 loses electric force, so that adhesive force to the solar panel 18A or the radiator 18B due to electrostatic attraction of the regolith 32 weakens. Hereby, the regolith 32 can be easily blown off from the surface of the solar panel 18A or the radiator 18B, and the regolith 32 thus blown off can be restrained from being reattached to the solar panel 18A or the radiator 18B. Note that, in FIG. 1, ions on the charged regolith 32 are expressed as particles indicated by a reference sign 40.

Dust Removal Apparatus 42 according to Second Embodiment

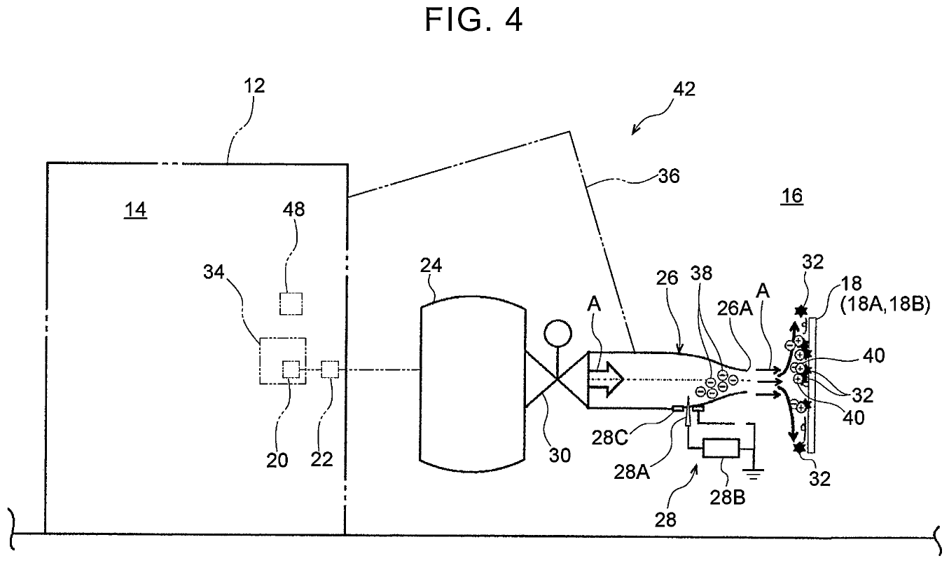

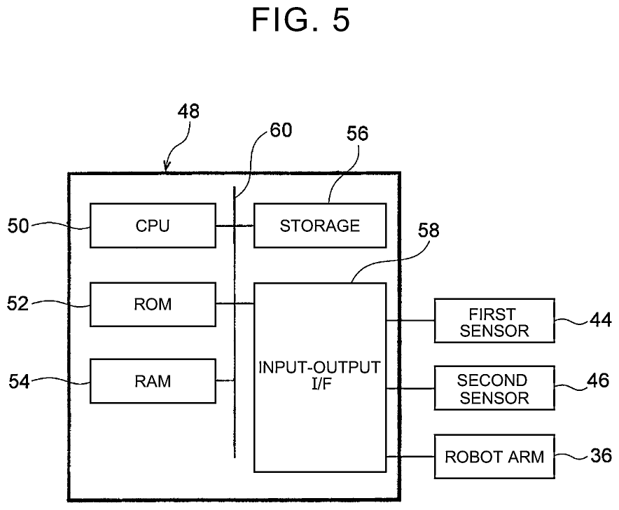

Next will be described a dust removal apparatus 42 according to a second embodiment of the present disclosure with reference to FIGS. 4, 5. Note that, in the dust removal apparatus 42 according to the second embodiment, elements corresponding to the elements of the dust removal apparatus 10 according to the first embodiment have the same reference signs as those in the dust removal apparatus 10 according to the first embodiment, and descriptions thereof may be omitted.

As illustrated in FIG. 4, the dust removal apparatus 42 according to the second embodiment includes a first sensor 44 configured to detect the target object 18 or powder dust attached to the target object 18, a second sensor 46 configured to detect a pressure of the dust removal gas in the storage portion 24, and the robot arm 36 configured to move the jetting portion 26. Further, the dust removal apparatus 42 according to the second embodiment includes the flow rate adjusting portion 30, and a controlling portion 48 configured to control the ionizer portion 28 and the robot arm 36.

As illustrated in FIGS. 4, 5, the controlling portion 48 controls the flow rate adjusting portion 30, the ionizer portion 28, and the robot arm 36 based on information from the first sensor 44, the second sensor 46, and so on (described later). Hereby, more optimum dust removal can be performed based on information or the like on the target object 18 or the powder dust attached to the target object 18.

As illustrated in FIG. 5, the controlling portion 48 includes a central processing unit (CPU: a processor) 50, a read only memory (ROM) 52, a random access memory (RAM) 54, a storage 56, and an input-output interface (I/F) 58 configured to perform communication or the like with an external device. Further, the CPU 50, the ROM 52, the RAM 54, the storage 56, and the input-output interface 58 are communicably connected to each other via a bus 60. Further, the flow rate adjusting portion 30, the ionizer portion 28, the first sensor 44, the second sensor 46, the robot arm 36, and so on are connected to the input-output interface 58. The CPU 50 is a central processing unit and is configured to execute various programs and control the flow rate adjusting portion 30, the ionizer portion 28, and the robot arm 36. That is, the CPU 50 reads a control program from the ROM 52 or the storage 56 based on signals from the first sensor 44 and the second sensor 46 and executes the control program with the RAM 54 being used as a working storage so as to control the flow rate adjusting portion 30, the ionizer portion 28, and the robot arm 36.

The first sensor 44 is a camera provided outside the jetting portion 26 as one example. The controlling portion 48 estimates and determines an attached part, a type, or a material of the target object 18 or the powder dust attached to the target object 18 by use of image data captured by the first sensor 44. Further, the controlling portion 48 measures the distance between the jetting portion 26 and the target object 18 by use of the image data captured by the first sensor 44.

The second sensor 46 is a pressure sensor provided in the storage portion 24 as one example. The controlling portion 48 calculates the flow speed of the dust removal gas to be jetted out of the jetting portion 26 based on the pressure measured by the second sensor 46.

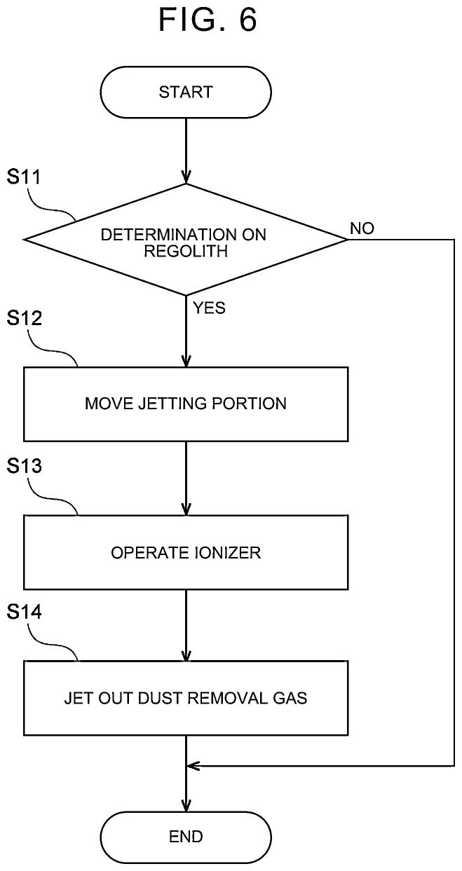

As illustrated in FIGS. 4, 6, in the dust removal apparatus 42 of the present embodiment described above, when the target object 18 is detected by the first sensor 44, the controlling portion 48 determines, in step S11, whether the regolith 32 as powder dust is attached to the target object 18 or not. When a negative determination is made in step S11, the controlling portion 48 ends the process. In the meantime, when an affirmative determination is made in step S11, the controlling portion 48 operates the robot arm 36, in step S12, such that the jetting portion 26 is brought close to the target object 18. At this time, the controlling portion 48 operates the robot arm 36 so that the distance between the jetting portion 26 and the target object 18 reaches a predetermined distance. Subsequently, the controlling portion 48 operates the ionizer portion 28 in step S13. Subsequently, in step S14, the controlling portion 48 operates (adjusts) the flow rate adjusting portion 30 so that the flow speed of the dust removal gas to be jetted out of the distal end opening 26A of the jetting portion 26 toward the target object 18 reaches a predetermined flow speed, and the controlling portion 48 starts jetting of the dust removal gas mixed with ions from the jetting portion 26. Note that the jetting of the dust removal gas from the jetting portion 26 is stopped after a predetermined period of time passes. When the controlling portion 48 repeats the processes after step S11, the jetting of the dust removal gas from the jetting portion 26 is performed repeatedly until the regolith 32 is removed from the target object 18.

As described above, in the present embodiment, when the controlling portion 48 controls the operations of the flow rate adjusting portion 30, the ionizer portion 28, and the robot arm 36, the regolith 32 attached to the target object 18 can be removed.

Flow Speed of Dust Removal Gas Necessary to Blow off Regolith 32

Next will be described a necessary flow speed of the dust removal gas to blow off the regolith 32.

The adhesive force of the regolith 32 attached to the target object 18 mainly includes van der Waals force and electrostatic attraction between the surface of the target object 18 and the regolith 32.

According to Reference 1 (Kato, Removal of Particles Attached to Surface Using High Speed Air Jet, Kyoto University Research Information Repository, 1995), an adhesive force Fd [N] caused by van der Waals force can be estimated by the following formula.

$$Fd = \frac{A \times Dp}{12 \times {zo}^{2}}$$

Here, A indicates a Hamaker constant [J], Dp indicates a particle diameter [m] of the regolith 32, and zo indicates a separation distance [m].

In a case where the target object 18 is the solar panel 18A or the radiator 18B, the material of the surface of the target object 18 is assumed SiO₂. Further, the regolith 32 is mainly constituted by SiO₂. In this case, the adhesive force Fd is calculated on the premise that A is equal to 1.6e⁻¹⁹ [J], a minimum particle diameter Dp of the regolith 32 is equal to 20 [μm], and as for the separation distance in the calculation of van der Waals force, zo is equal to 4 [Å] when objects make contact with each other. The calculated adhesive force Fd is 1.7e⁻⁶ [N].

Further, an adhesive force Fe [N] caused by electrostatic attraction can be estimated by the following formula based on Reference 2 (Masuda, Adhesive force and Cohesive Force of Powder Particles, the Journal of Society of Electrophotography of Japan, Volume 36, No. 3, 1997).

$$Fs = \frac{1}{4 {πɛ}_{0}} \frac{{Q}^{2}}{{d}^{2}}$$

Here, ϵ₀ indicates the permittivity of vacuum (=8.85e⁻¹² [F/m]), Q indicates a charge amount (ϵ₀ES) [C], and d indicates a distance between two objects and is ½ of the minimum particle diameter Dp of the regolith 32. Further, E indicates an electric field intensity and is 20 [MV/m] at the maximum in a vacuum state, and S indicates a particle surface area [m²] of the regolith 32. The adhesive force Fe calculated from these values is 3.1e⁻⁸ [N].

Next, a removal force Fr [N] that exceeds an adhesive force Fd+Fs is considered. The removal force Fr can be estimated by the following formula according to Reference 1 (Kato, Removal of Particles Attached to Surface Using High Speed Air Jet, Kyoto University Research Information Repository, 1995) described above.

Fr=k×Pd

Here, Pd indicates a dynamic pressure [Pa] of an air flow acting on particles of the regolith 32, and k indicates a coefficient indicative of a proportion of the action on the particles. According to Reference 1 (Kato, Removal of Particles Attached to Surface Using High Speed Air Jet, Kyoto University Research Information Repository, 1995), k=0.8 is a corresponding coefficient based on calculation and experimental results. Accordingly, the consideration herein also employs k=0.8.

Further, the dynamic pressure is kinetic energy. Accordingly, when the dynamic pressure is found, the necessary flow speed of the dust removal gas to remove (blow off) the regolith 32 can be found. Based on the foregoing, when the gas density of carbon dioxide is roughly estimated as 1.976 [kg/m³], a flow speed V of the dust removal gas >85 [m/s] is found from a relational expression of Fr>Fd+Fe. That is, a minimum value of the necessary flow speed of the dust removal gas to remove the regolith 32 is estimated as 85 [m/s]. In consideration of these matters, the pressure of the dust removal gas inside the storage portion 24, the size of the flow rate adjusting portion 30, the shape of the jetting portion 26, and so on should be set.

Further, based on information on the target object 18 to be hit by gas jetted out of the jetting portion 26 and the powder dust attached to the target object 18, the controlling portion 48 adjusts the flow speed of the gas to be jetted out of the jetting portion 26 such that the flow speed reaches a flow speed equal to or higher than the minimum value. Hereby, it is possible to surely remove the powder dust attached to the target object 18.

Necessary Applied Voltage to Ionizer Portion 28 to Blow off Regolith 32

Next will be described a necessary applied voltage to the ionizer portion 28 to blow off the regolith 32.

According to Reference 3 (J. P. Pabari, Levitation of charged dust grains and its implications in lunar environment, CURRENTSCIENCE, Vol. 110, No. 10, 2016), when a large-scale solar flare occurs, a lunar surface potential of −4.5 [kV] at the maximum is observed on the far side of the moon. Note that a maximum value of the lunar surface potential on the positive side is about several dozens of voltage [V]. Accordingly, based on the maximum value, it is desirable that an applied voltage of up to about 10 [kV] be applicable to the ionizer portion 28.

In consideration of this, the controlling portion 48 adjusts a voltage to be applied to the ionizer portion 28 based on information on the potential (lunar surface potential) around the work room 12. Hereby, it is possible to more surely restrain reattachment of the powder dust removed from the target object 18.

Shape of Jetting Portion 26

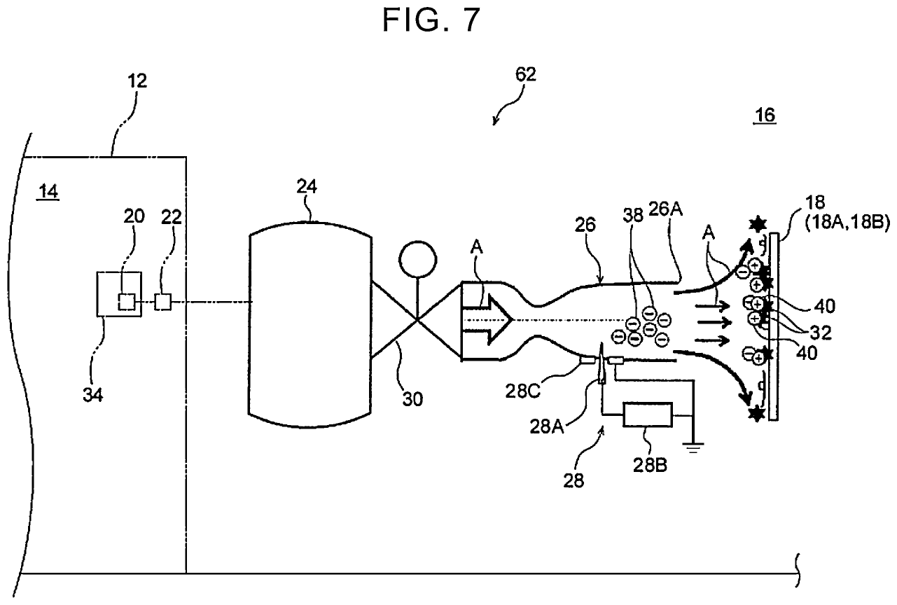

In the exemplary dust removal apparatuses 10, 42 described above, the jetting portion 26 has a convergent nozzle shape. Here, like a dust removal apparatus 62 according to a third embodiment illustrated in FIG. 7, the jetting portion 26 has a shape of a de Laval nozzle. Hereby, the flow speed of the dust removal gas in the distal end opening 26A of the jetting portion 26 is raised to be equal to or higher than a supersonic speed, so that inertial force of the dust removal gas increases. This consequently restrains expansion of the dust removal gas in the distal end opening 26A of the jetting portion 26. That is, slowing-down of the dust removal gas in the distal end opening 26A of the jetting portion 26 is restrained. Further, in this case, the flow speed of the dust removal gas in the distal end opening 26A of the jetting portion 26 is a supersonic speed (the number of Mach exceeds 1), so that the flow speed of the dust removal gas in the distal end opening 26A of the jetting portion 26 is generally 340 [m/s] or more. On this account, the minimum value of the necessary flow speed of the dust removal gas to remove the regolith 32 is equal to or more than four times of 85 [m/s], thereby making it possible to effectively remove finer powder dust (powder dust of 20 μm or less) of the regolith 32. Further, this also makes it possible to remove such powder dust in short time.

Vehicle Including Dust Removal Apparatus

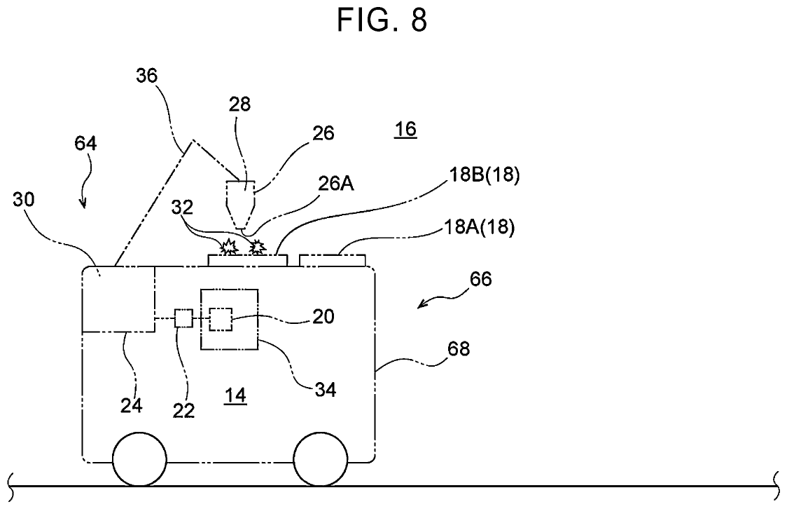

Next will be described a vehicle 66 including a dust removal apparatus 64 with reference to FIG. 8. Note that, in the dust removal apparatus 64 provided in the vehicle 66, elements corresponding to the elements of the dust removal apparatus 10, 42, 62 described above have the same reference signs as those in the dust removal apparatus 10, 42, 62 described above, and descriptions thereof may be omitted.

As illustrated in FIG. 8, the vehicle 66 including the dust removal apparatus 64 is a vehicle intended to travel on the surface of the moon. The vehicle 66 includes a vehicle main body 68 having the space 14 inside which an occupant rides and configured to separate the space 14 inside the vehicle main body 68 from the space 16 outside the vehicle main body 68 in a state where no gas is passable between the space 14 and the space 16. Further, the vehicle 66 includes the solar panel 18A and the radiator 18B attached to the vehicle main body 68, the robot arm 36 supported by the vehicle main body 68, and the dust removal apparatus 64 including the jetting portion 26 attached to the robot arm 36.

In the vehicle 66 described above, unnecessary carbon dioxide and steam in the space 14 inside the vehicle main body 68 are collected by the collecting portion 20 constituting part of the life support system 34 of the dust removal apparatus 64. That is, the dust removal gas is collected by the collecting portion 20.

Further, the dust removal gas collected by the collecting portion 20 is compressed by the compression portion 22 and stored in the storage portion 24.

Here, when attachment of the regolith 32 to the solar panel 18A or the radiator 18B is detected, the robot arm 36 operates, so that the jetting portion 26 is placed near the solar panel 18A or the radiator 18B. Subsequently, the ionizer portion 28 operates, and the flow rate adjusting portion 30 also operates, so that the dust removal gas mixed with the ions is jetted out of the jetting portion 26 toward the solar panel 18A or the radiator 18B. Hereby, in the vehicle 66 of the present embodiment, even in a case where the regolith 32 raised along with traveling of the vehicle 66 is attached to the solar panel 18A or the radiator 18B, for example, it is possible to remove the regolith 32 attached to the solar panel 18A or the radiator 18B.

Note that the dust removal apparatus 10, 42, 62, 64 described above has been described with an example in which carbon dioxide and steam are used as the dust removal gas. However, the present disclosure is not limited to this. For example, air, oxygen, hydrogen, and the like may be used as the dust removal gas. Here, in a case where the air is used as the dust removal gas, when the ionizer portion 28 is operated, O₂⁻, CO₃⁻, NO₂⁻, O⁻, O₃⁻ ions can be mixed into the dust removal gas. Further, in a case where oxygen is used as the dust removal gas, when the ionizer portion 28 is operated, O₂⁻, O⁻, O₃⁻ ions can be mixed into the dust removal gas. Further, in a case where hydrogen is used as the dust removal gas, when the ionizer portion 28 is operated, electric-charge e ions can be mixed into the dust removal gas.

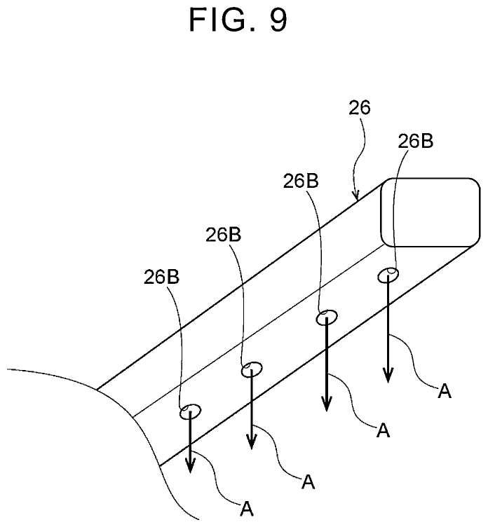

Further, the dust removal apparatus 10, 42, 62, 64 described above has been described with an example in which the jetting portion 26 configured such that the dust removal gas is jetted out of the single distal end opening 26A. However, the present disclosure is not limited to this. As illustrated in FIG. 9, for example, the dust removal apparatus may be configured to use the jetting portion 26 having a tubular shape and having a plurality of jetting openings 26B placed at intervals in the axial direction of the jetting portion 26. In this configuration, the dust removal gas is jetted out of the jetting openings 26B of the jetting portion 26. Hereby, in comparison with the configuration using the jetting portion 26 configured such that the dust removal gas is jetted out of the single distal end opening 26A, the dust removal gas can be jetted out to a wide range of the target object 18. Hereby, it is possible to remove the powder dust attached to the target object 18 in short time.

Further, the dust removal apparatus 10, 42, 62, 64 described above is configured to remove the regolith 32 on the surface of the moon. However, the present disclosure is not limited to this. For example, by changing some setting, the dust removal apparatus 10, 42, 62, 64 can be configured to perform dust removal on other celestial objects such as Mars. Further, the dust removal apparatus 10, 42, 62, 64 may be configured to perform dust removal on the earth. Further, the dust removal apparatus 10, 42, 62, 64 may be configured to perform dust removal from other target objects 18 other than the solar panel 18A or the radiator 18B.

Embodiments of the present disclosure have been described above, but the present disclosure is not limited to the above description and may be modified in various ways to be performed as long as the modifications are not beyond the gist thereof.

What is claimed is:

1. A dust removal apparatus comprising:
a collecting portion configured to collect gas existing inside an internal space forming portion configured to separate a space inside the internal space forming portion from a space outside the internal space forming portion in a state where the gas is not circulable;
a compression portion configured to compress the gas collected by the collecting portion;
a jetting portion configured to jet out the gas compressed by the compression portion, the jetting portion being provided in the space outside the internal space forming portion; and
an ionizer portion configured to mix ions into the gas jetted out of the jetting portion when a voltage is applied to the ionizer portion, the ionizer portion being provided between the compression portion and the jetting portion.

2. The dust removal apparatus according to claim 1, wherein the internal space forming portion is provided in a state where the internal space forming portion is movable on a celestial object in outer space or in a state where the internal space forming portion is fixed to the celestial object in the outer space.

3. The dust removal apparatus according to claim 1, wherein the collecting portion collects at least one of carbon dioxide and steam from among gases existing inside the internal space forming portion.

4. The dust removal apparatus according to claim 1, further comprising a controlling portion configured to, based on information on a blast target object to be hit by the gas jetted from the jetting portion and powder dust attached to the blast target object, adjust a flow speed of the gas to be jetted out of the jetting portion.

5. The dust removal apparatus according to claim 4, wherein the controlling portion adjusts a voltage to be applied to the ionizer portion based on information on a potential around the internal space forming portion.

6. The dust removal apparatus according to claim 1, wherein:
the internal space forming portion includes a power generation portion configured to generate electric power upon receipt of light; and
the gas is jetted out of the jetting portion to the power generation portion.

7. The dust removal apparatus according to claim 1, wherein:
the internal space forming portion includes a heat dissipation portion configured to dissipate heat; and
the gas is jetted out of the jetting portion to the heat-dissipation portion.

8. A vehicle comprising:
a vehicle main body having a space inside which an occupant rides, the vehicle main body being configured to separate the space inside the vehicle main body from a space outside the vehicle main body in a state where no gas is circulable, the vehicle main body being configured to travel on ground;
a collecting portion configured to collect gas existing inside the vehicle main body;
a compression portion configured to compress the gas collected by the collecting portion;
a jetting portion configured to jet out the gas compressed by the compression portion, the jetting portion being provided in the space outside the vehicle main body; and
an ionizer portion configured to mix ions into the gas to be jetted out of the jetting portion when a voltage is applied to the ionizer portion, the ionizer portion being provided between the compression portion and the jetting portion.

9. A dust removal method comprising:
a gas collecting step of collecting gas existing inside an internal space forming portion configured to separate a space inside the internal space forming portion from a space outside the internal space forming portion in a state where the gas is not circulable;
a compression step of compressing the gas collected in the gas collecting step;
an ion mixing step of mixing ions into the gas when the gas compressed in the compression step is expanded; and
a jetting step of jetting out the gas mixed with the ions in the ion mixing step to a blast target object in the space outside the internal space forming portion.

10. The dust removal method according to claim 9, wherein, based on information on a blast target object to be hit by the gas jetted out in the jetting step and powder dust attached to the blast target object, a flow speed of the gas to be jetted out in the jetting step is adjusted.

11. The dust removal method according to claim 10, wherein a voltage to be applied in the ion mixing step is adjusted based on information on a potential around the internal space forming portion.
